(19) United States
(12) Patent Application Publication
(10) Pub. No.: US 2026/0299461 A1
(43) Pub. Date: Oct. 1, 2026

(54) DEVELOPING DEVICE AND IMAGE FORMING APPARATUS

(71) Applicant: FUJIFILM Business Innovation Corp., Tokyo (JP)

(72) Inventors: Sadayuki TSUJINO, Kanagawa (JP); Yasuki TANAKA, Kanagawa (JP); Kazuki KISHI, Kanagawa (JP)

(73) Assignee: FUJIFILM Business Innovation Corp., Tokyo (JP)

(21) Appl. No.: 19/263,531

(22) Filed: Jul. 9, 2025

(30) Foreign Application Priority Data
Mar. 25, 2025 (JP) 2025-050657

(51) Int. Cl. G03G 15/08

(52) U.S. Cl. CPC G03G 15/0813; G03G 15/0808

(57) ABSTRACT

A developing device that is composed of plural constituent members and that causes a developer to adhere to an image holding body holding an image includes a facing member that is disposed as a constituent member to be rotatable at a position facing the image holding body and that includes a magnetic pole acting such that the developer is separated, a second accommodation portion that is provided separately from a first accommodation portion accommodating the developer to be supplied to the facing member, that receives and accommodates the developer separated from the facing member, and in which the accommodated developer is transported as a transport member rotates, and a partition wall that partitions a space between the facing member and the second accommodation portion except a region for reception of the developer separated from the facing member, in which, in a case of being seen in a direction along a rotation axis of the transport member such that the image holding body is positioned to left of the facing member, the rotation axis of the transport member is positioned above or to right of a first virtual line passing through a rotation center of the facing member and the magnetic pole, the transport member rotates in a direction away from the facing member in the region for the reception, and a second virtual line extending in a tangential direction at a position of a left end of the region for the reception does not intersect the facing member.

### CROSS-REFERENCE TO RELATED APPLICATIONS

This application is based on and claims priority under 35 USC 119 from Japanese Patent Application No. 2025-050657 filed Mar. 25, 2025.

### BACKGROUND

### (i) Technical Field

The present invention relates to a developing device and an image forming apparatus.

### (ii) Related Art

For example, disclosed in JP2008-15279A is a developing device including a development housing that is open toward an image carrier carrying an electrostatic latent image and that can accommodate a two-component developer containing toner and a magnetic carrier. The developing device includes a developer carrier that is disposed to face an opening of the development housing and that includes a development sleeve that is rotatable and that has a surface on which the developer can be carried and transported. The developer carrier includes a magnet body that is provided inside the development sleeve and in which a plurality of magnetic poles, which include adjacent repulsive magnetic poles of the same polarity at least, are fixed and disposed. Furthermore, the developing device includes a pressing member that is provided to be close to the development sleeve, that is provided to cover, from a position upstream of a magnetic pole on an upstream side in a developer transportation direction which is one of the repulsive magnetic poles, at least the magnetic pole width of the magnetic pole, and that is provided not to reach a pick-off portion formed by the repulsive magnetic poles. The pressing member presses the developer on the development sleeve against the development sleeve.

### SUMMARY

Here, a configuration in which a facing member that is disposed at a position facing an image holding body that holds an image, a first accommodation portion that accommodates a developer to be supplied to the facing member, and a second accommodation portion that is provided separately from the first accommodation portion and that accommodates a developer separated from the facing member are provided will be considered. In such a configuration, a phenomenon in which the developer separated from the facing member leaps up is likely to occur in a case where an interval between the first accommodation portion and the second accommodation portion is narrowed or the image holding body is rotated at a high speed. The phenomenon in which the developer leaps up may cause a situation in which the developer separated from the facing member adheres to the facing member again.

Aspects of non-limiting embodiments of the present disclosure relate to a developing device and an image forming apparatus that suppress occurrence of a situation in which a developer separated from a facing member adheres to the facing member again in comparison with a case where a configuration that makes a phenomenon in which the developer separated from the facing member leaps up less likely to occur is not adopted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device that is composed of a plurality of constituent members and that causes a developer to adhere to an image holding body holding an image, the developing device including a facing member that is disposed as a constituent member to be rotatable at a position facing the image holding body and that includes a magnetic pole acting such that the developer is separated, a second accommodation portion that is provided separately from a first accommodation portion accommodating the developer to be supplied to the facing member, that receives and accommodates the developer separated from the facing member, and in which the accommodated developer is transported as a transport member rotates, and a partition wall that partitions a space between the facing member and the second accommodation portion except a region for reception of the developer separated from the facing member, in which, in a case of being seen in a direction along a rotation axis of the transport member such that the image holding body is positioned to left of the facing member, the rotation axis of the transport member is positioned above or to right of a first virtual line passing through a rotation center of the facing member and the magnetic pole, the transport member rotates in a direction away from the facing member in the region for the reception, and a second virtual line extending in a tangential direction at a position of a left end of the region for the reception does not intersect the facing member.

### BRIEF DESCRIPTION OF THE DRAWINGS

Exemplary embodiment(s) of the present invention will be described in detail based on the following figures, wherein:

FIG. 1 is a view illustrating an image forming apparatus;

FIG. 2 is a view of a developing device as seen from above;

FIG. 3 is a cross-sectional view of the developing device taken along line III-III in FIG. 2;

FIG. 4 is a cross-sectional view of the developing device taken along line IV-IV in FIG. 2;

FIG. 5 is a cross-sectional view of the developing device taken along line V-V in FIG. 2;

FIG. 6 is a view for description of a developing device according to a first exemplary embodiment;

FIG. 7 is a view for description of a major part of the developing device; and

FIG. 8 is a view for description of a developing device according to a second exemplary embodiment.

### DETAILED DESCRIPTION

Hereinafter, an exemplary embodiment of the present invention will be described in detail with reference to the accompanying drawings.

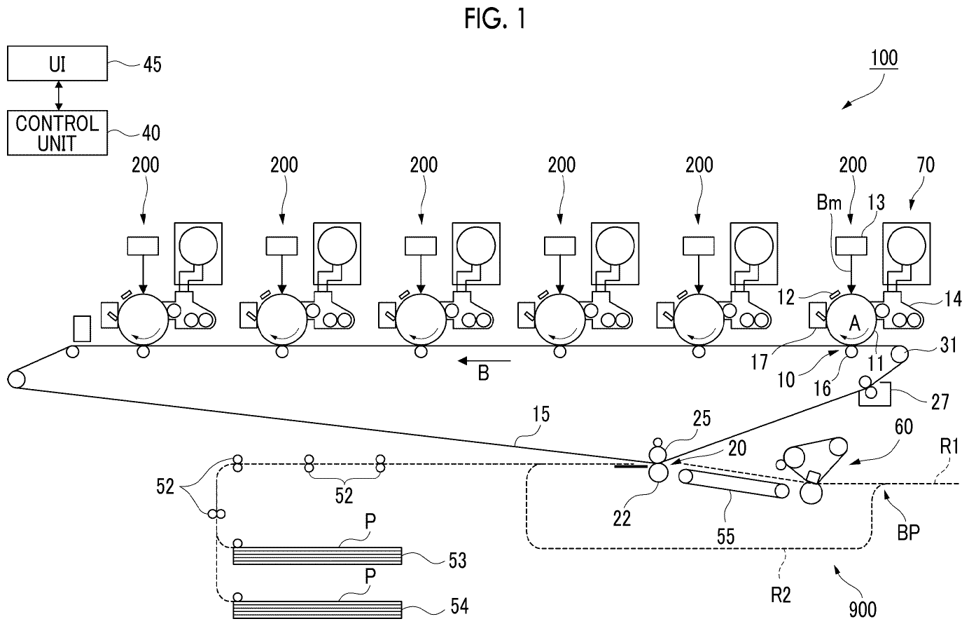

FIG. 1 is a view showing an image forming apparatus 100 according to the present exemplary embodiment. FIG. 1 shows a state related to a case where the image forming apparatus 100 is seen from a side ahead of the image forming apparatus 100.

The image forming apparatus 100 is an intermediate transfer type image forming apparatus 100, which is called a tandem type image forming apparatus.

The image forming apparatus 100 is provided with a plurality of image forming units that form images to be transferred to a paper sheet P, which is an example of a recording medium.

Each of the image forming units 200 includes a photoreceptor drum 11 which is an example of an image holding body. Each of the image forming units 200 forms a toner image, which is an image to be transferred to the paper sheet P, on the photoreceptor drum 11 by using a developer containing toner. In other words, each of the image forming units 200 forms, on the photoreceptor drum 11 by using a powdery developer, a toner image to be transferred to the paper sheet P.

A developer of the present exemplary embodiment is composed of a dry carrier and dry toner. Each of the image forming units 200 uses a carrier and toner to form a toner image on the photoreceptor drum 11.

Six image forming units 200 form toner images on the photoreceptor drums 11 by using different types of developers.

Specifically, in the present exemplary embodiment, four of the six image forming units 200 form toner images by using developers of basic colors which are yellow, magenta, cyan, and black.

In addition, the remaining two image forming units 200 form toner images by using a developer of a color other than the basic colors, such as clear, white, gold, silver, pink, green, or orange.

Note that examples of the developer of a color other than the basic colors include a developer containing magnetic toner and a developer containing conductive toner, in addition to the above-described developer. In addition, examples of the developer of a color other than the basic colors include a developer containing toner that emits light in a case where the toner is irradiated with light such as ultraviolet rays or infrared rays.

In the present exemplary embodiment, a so-called two-component developer in which a carrier and toner are mixed with each other is used as the developer. However, the developer is not limited thereto. That is, as the developer, a so-called one-component developer composed of toner alone may also be used.

In addition, the image forming apparatus 100 is provided with an intermediate transfer belt 15. In addition, the image forming apparatus 100 is provided with primary transfer units 10 provided to transfer toner images to the intermediate transfer belt 15, the toner images being respectively formed by the image forming units 200.

Furthermore, the image forming apparatus 100 is provided with a secondary transfer unit 20 provided to transfer, to the paper sheet P, the toner images transferred onto the intermediate transfer belt 15.

In addition, the image forming apparatus 100 is provided with a fixing device 60 that fixes, onto the paper sheet P, the toner images transferred onto the paper sheet P.

Furthermore, the image forming apparatus 100 is provided with a control unit 40 that includes a CPU executing a program. The control unit 40 controls each unit in the image forming apparatus 100.

In addition, the image forming apparatus 100 is provided with a user interface (UI) 45 that is composed of a display panel or the like, that receives an instruction from a user, and that displays information with respect to the user.

Each of the image forming units 200 is provided with a developing device 14. In addition, each of the image forming units 200 is provided with a developer replenishment device 70 that replenishes the developing device 14 with a developer.

The developing device 14 visualizes an electrostatic latent image on the photoreceptor drum 11 with toner. In other words, the developing device 14 performs development with respect to the photoreceptor drum 11, which is an image holding body, to form, on the photoreceptor drum 11, an image formed by the toner.

The developer replenishment device 70 replenishes the developing device 14 with a developer. As described above, a developer is composed of a carrier and toner, and the developer replenishment device 70 replenishes the developing device 14 with a carrier and toner as a developer. Note that in the present exemplary embodiment, a carrier has a positive charging polarity, and toner has a negative charging polarity.

In each of the image forming units 200, the photoreceptor drum 11 rotates in a direction along an arrow A.

In addition, each of the image forming units 200 is provided with a charger 12 that charges the photoreceptor drum 11 and a laser exposure device 13 which is an example of an exposure device forming an electrostatic latent image on the photoreceptor drum 11. In FIG. 1, an exposure beam from the laser exposure device 13 is represented by a reference numeral “Bm”. Note that the exposure device may be composed of a device including a light source, such as an LED.

In addition, each of the image forming units 200 is provided with a primary transfer roll 16 that transfers a toner image formed on the photoreceptor drum 11 to the intermediate transfer belt 15 at the primary transfer unit 10. In addition, each of the image forming units 200 is provided with a drum cleaner 17 that removes a developer remaining on the photoreceptor drum 11.

A drive roll 31 driven by a motor (not shown) causes the intermediate transfer belt 15 to circulate and move at a predetermined speed in a direction along an arrow B which is shown in FIG. 1.

The primary transfer unit 10 is configured to include the primary transfer roll 16 that is disposed to face the photoreceptor drum 11 with the intermediate transfer belt 15 interposed therebetween. In addition, respective toner images on the photoreceptor drums 11 are electrostatically attracted onto the intermediate transfer belt 15 in order, so that superimposed toner images are formed on the intermediate transfer belt 15.

The secondary transfer unit 20 which is an example of a transfer unit is configured to include a secondary transfer roll 22 that is disposed on an outer surface side of the intermediate transfer belt 15. In addition, the secondary transfer unit 20 is configured to include a backup roll 25 that is disposed on an inner surface side of the intermediate transfer belt 15.

In the present exemplary embodiment, at the secondary transfer unit 20, toner images that are formed by the image forming units 200 and that are transferred to the intermediate transfer belt 15 are transferred to the paper sheet P transported to the secondary transfer unit 20.

Furthermore, in the present exemplary embodiment, an inversion mechanism 900 that inverts the paper sheet P is provided.

The inversion mechanism 900 inverts the paper sheet P with one surface on which the toner images have been transferred at the secondary transfer unit 20 upside down and supplies the paper sheet P again to the secondary transfer unit 20.

Accordingly, in the present exemplary embodiment, toner images can be formed on both surfaces of the paper sheet P.

Specifically, in the present exemplary embodiment, the inversion mechanism 900 inverts the paper sheet P upside down by feeding the paper sheet P, which has passed through the fixing device 60, to a branch path R2 branching off a paper sheet transport path R1. Specifically, after the paper sheet P passes through a branching portion BP, the inversion mechanism 900 transports the paper sheet P in a reverse direction and feeds the paper sheet P to the branch path R2.

The branch path R2 joins the paper sheet transport path R1 at a position upstream of the secondary transfer unit 20. Accordingly, in the present exemplary embodiment, the paper sheet P inverted upside down is supplied again to the secondary transfer unit 20. In this case, toner images are formed not only on the one surface of the paper sheet P but also on the other surface of the paper sheet P, so that the toner images are formed on both surfaces of the paper sheet P.

The flow of processing performed in the image forming apparatus 100 will be described.

The image forming apparatus 100 receives image data output from, for example, an image reading apparatus (not shown) or a computer. Then, the image data is subjected to image processing. Accordingly, image data corresponding to each of the plurality of image forming units 200 is generated.

Specifically, for example, image data used for image formation in which the developers of the basic colors, which are yellow, magenta, cyan, and black, are used and image data used for image formation in which the developer of a color other than the basic colors is used are generated. The generated image data is output to the laser exposure devices 13 provided at the image forming units 200.

In accordance with the image data input to the laser exposure devices 13, the laser exposure devices 13 irradiate the photoreceptor drums 11 with the exposure beams Bm emitted from, for example, semiconductor lasers.

In the present exemplary embodiment, after respective surfaces of the photoreceptor drums 11 are charged by the chargers 12, the surfaces are scanned and exposed to light by the laser exposure devices 13. Accordingly, electrostatic latent images are formed on the surfaces of the photoreceptor drums 11.

Next, development processing is performed by the developing devices 14 so that toner images are formed on the photoreceptor drums 11. The toner images are transferred onto the intermediate transfer belt 15 at the primary transfer units 10.

After the toner images are transferred onto the intermediate transfer belt 15, the toner images are moved to the secondary transfer unit 20 as the intermediate transfer belt 15 moves. In addition, at this time, the paper sheet P from a first paper sheet accommodation portion 53 or a second paper sheet accommodation portion 54 is transported to the secondary transfer unit 20 by transport rolls 52 or the like.

Then, the toner images on the intermediate transfer belt 15 are electrostatically transferred onto the paper sheet P in a collective manner at the secondary transfer unit 20.

Thereafter, the paper sheet P onto which the toner images have been transferred is separated from the intermediate transfer belt 15 and is transported to a transport belt 55. The transport belt 55 transports the paper sheet P to the fixing device 60.

The paper sheet P transported to the fixing device 60 is heated and pressed by the fixing device 60. Accordingly, the toner images on the paper sheet P are fixed to the paper sheet P. Then, the paper sheet P is discharged from the image forming apparatus 100.

Note that in a case where toner images are to be formed on both surfaces of the paper sheet P, the paper sheet P is supplied again to the secondary transfer unit 20 through the branch path R2 after the paper sheet P passes through the fixing device 60.

Then, toner images are transferred to the other surface of the paper sheet P at the secondary transfer unit 20. Thereafter, the paper sheet P passes through the fixing device 60 again and the toner images transferred to the other surface are fixed to the paper sheet P.

The developing devices 14 will be described.

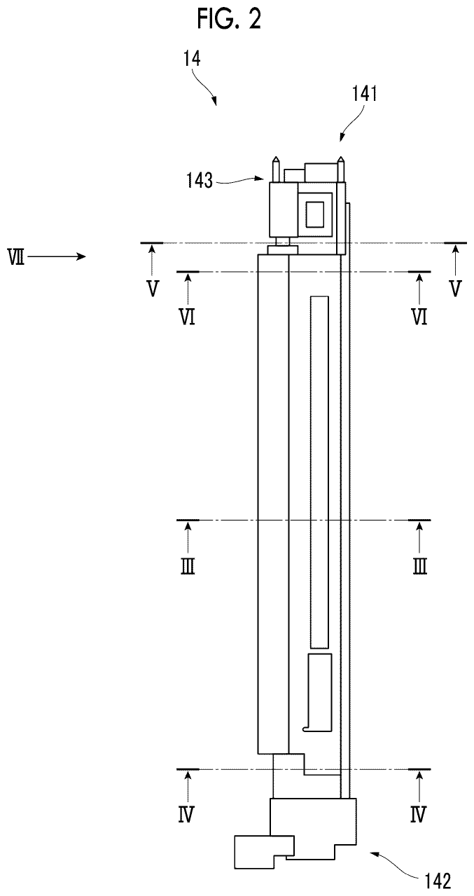

FIG. 2 is a view showing the developing device 14 as seen from above.

In a case where the developing device 14 is installed in the image forming apparatus 100, the developing device 14 is disposed along a depth direction of the image forming apparatus 100. The developing device 14 includes one end portion 141 and the other end portion 142, of which the positions are different from each other in a longitudinal direction.

In a case where the developing device 14 is installed in the image forming apparatus 100, the developing device 14 is installed in the image forming apparatus 100 such that the one end portion 141 is positioned on a rear side of the image forming apparatus 100 and the other end portion 142 is positioned on a front side of the image forming apparatus 100.

A drive force receiving portion 143 that receives a drive force is provided at the one end portion 141 of the developing device 14.

In the present exemplary embodiment, a drive force from a drive source (not shown), such as a motor, is transmitted to the drive force receiving portion 143, the drive source being provided on a body side of the image forming apparatus 100.

The drive force receiving portion 143 is linked to a transport member or the like (which will be described later) provided inside the developing device 14. In the present exemplary embodiment, the transport member or the like is rotated as the drive force from the drive source is transmitted to the drive force receiving portion 143.

In the present exemplary embodiment, as will be described later, four members, which are an one-direction transport member, an opposite-direction transport member, a facing member, and a lower-side transport member, are provided as members that rotate as the drive force is received from the drive source. The drive force receiving portion 143 may be provided to correspond to each of the four members. In addition, a drive force from the drive source may be transmitted to each of four drive force receiving portions 143.

In addition, alternatively, drive force receiving portions 143 of which the number is smaller than the number of the four members, for example, one drive force receiving portion 143, may be provided. In addition, a drive force transmitted from the drive source to the drive force receiving portion 143 may be transmitted to each of the four members through a transmission mechanism (not shown) provided at the developing device 14.

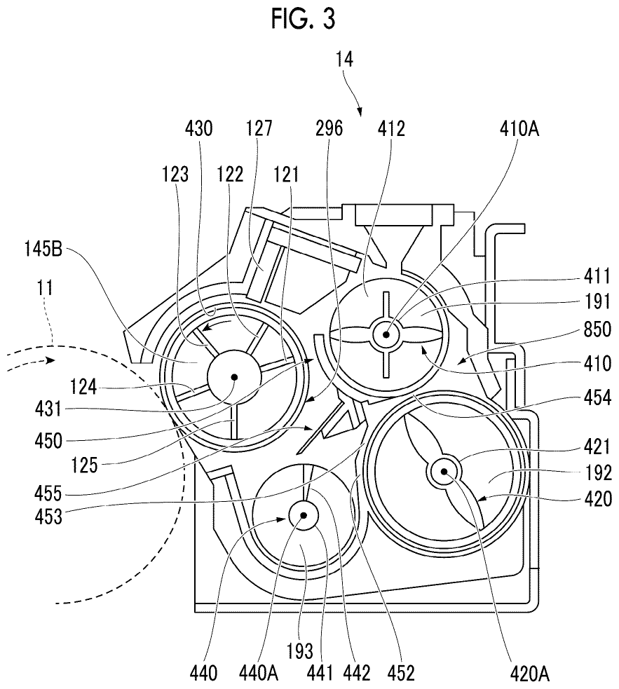

FIG. 3 is a cross-sectional view of the developing device 14 taken along line III-III in FIG. 2. FIG. 3 shows the state of a cross section of a central portion of the developing device 14 in the longitudinal direction.

The developing device 14 is provided with an one-direction movement path 191 through which a developer passes in a case where the developer is to be moved in one direction.

In addition, the developing device 14 is provided with an opposite-direction movement path 192 through which the developer passes in a case where the developer is to be moved in a direction opposite to the one direction. The opposite-direction movement path 192 is disposed below the one-direction movement path 191.

In the one-direction movement path 191, the developer moves in a direction perpendicular to the paper surface of FIG. 3 and in a direction to the rear side of the paper surface. In addition, in the opposite-direction movement path 192, the developer moves in a direction perpendicular to the paper surface of FIG. 3 and in a direction to the front side of the paper surface.

The one-direction movement path 191 is provided with an one-direction transport member 410 that transports the developer. In the present exemplary embodiment, the developer moves in the direction to the rear side as the one-direction transport member 410 rotates around a rotary shaft 411 that extends along the one-direction movement path 191.

More specifically, in the present exemplary embodiment, the developer moves in the direction to the rear side as the one-direction transport member 410 receives a drive force transmitted from the above-described drive force receiving portion 143 (refer to FIG. 2) and the one-direction transport member 410 rotates.

In the present exemplary embodiment, the one-direction transport member 410 transports the developer in the direction to the rear side, which is the one direction. The one-direction transport member 410 is a rotating member that rotates around an axis 410A extending along the one direction.

The opposite-direction movement path 192 is provided with an opposite-direction transport member 420 that transports the developer. The opposite-direction transport member 420 is disposed below the one-direction transport member 410.

In the present exemplary embodiment, the developer moves in the direction to the front side as the opposite-direction transport member 420 rotates around a rotary shaft 421 that extends along the opposite-direction movement path 192.

More specifically, the developer moves in the direction to the front side as the opposite-direction transport member 420 receives a drive force transmitted from the above-described drive force receiving portion 143 and the opposite-direction transport member 420 rotates.

In the present exemplary embodiment, the opposite-direction transport member 420 transports the developer in the direction opposite to the one direction.

A facing member 430 that is disposed at a position facing the photoreceptor drum 11 is provided to the left of the one-direction transport member 410.

The facing member 430 supplies, to the photoreceptor drum 11, a developer supplied from the one-direction transport member 410. The developer is supplied from the one-direction transport member 410 to the facing member 430 and the facing member 430 supplies the developer to the photoreceptor drum 11.

The facing member 430 is composed of a cylindrical body. The facing member 430 is formed of, for example, a metal such as SUS.

The facing member 430 receives a drive force transmitted from the drive force receiving portion 143 (refer to FIG. 2) and rotates in a counterclockwise direction in the drawing around an axis 431. Furthermore, the facing member 430 moves, to the photoreceptor drum 11, a developer that is supplied from the one-direction transport member 410 and that adheres to an outer peripheral surface of the facing member 430.

Accordingly, the developer is supplied to the photoreceptor drum 11, and toner contained in the developer adheres to a surface of the photoreceptor drum 11.

The facing member 430 is a rotating member that rotates around the axis 431 extending along the above-described one direction. In addition, the one-direction transport member 410 is also a rotating member that rotates around the axis 410A extending along the above-described one direction.

In the present exemplary embodiment, the facing member 430 and the one-direction transport member 410 are provided such that the axis 410A of the one-direction transport member 410 is positioned above the axis 431 of the facing member 430.

Furthermore, in the present exemplary embodiment, a first movement restriction portion 450 disposed between the facing member 430 and the one-direction transport member 410 is provided. The first movement restriction portion 450 restricts movement of a portion of a developer caused to move toward the facing member 430 from the one-direction transport member 410.

In the present exemplary embodiment, a portion of a developer on the one-direction movement path 191 that moves over the first movement restriction portion 450 is supplied to the facing member 430.

Furthermore, in the present exemplary embodiment, a lower-side transport member 440 that is disposed below the facing member 430 is provided. The lower-side transport member 440 is a rotating member that rotates around an axis 440A extending along the above-described one direction.

The lower-side transport member 440 is disposed closer to the photoreceptor drum 11 side than the opposite-direction transport member 420 is.

The lower-side transport member 440 and the opposite-direction transport member 420 are disposed along the above-described one direction and are disposed in a state where the positions thereof are offset from each other in a horizontal direction.

The lower-side transport member 440 transports a developer separated from the facing member 430 in the direction perpendicular to the paper surface of FIG. 3 and in the direction to the rear side of the paper surface.

The lower-side transport member 440 transports the developer separated from the facing member 430 in the above-described one direction, so that the developer is supplied to one end portion side of the opposite-direction transport member 420 (details will be described later).

The lower-side transport member 440 is rotated by a drive force transmitted from the drive force receiving portion 143 (refer to FIG. 2). The lower-side transport member 440 transports a developer separated from the facing member 430 in the direction perpendicular to the paper surface of FIG. 3 and in the direction to the rear side of the paper surface.

The lower-side transport member 440 is provided on a lower-side movement path 193 that is disposed closer to the photoreceptor drum 11 side than the opposite-direction movement path 192 is.

The lower-side movement path 193 is disposed to extend in the direction perpendicular to the paper surface of FIG. 3 and is disposed below the facing member 430. In the present exemplary embodiment, the developer separated from the facing member 430 moves along the lower-side movement path 193.

Furthermore, in the present exemplary embodiment, a second movement restriction portion 452 disposed between the lower-side transport member 440 and the opposite-direction transport member 420 is provided. The second movement restriction portion 452 restricts movement of a portion of a developer moving toward the lower-side transport member 440 from the opposite-direction transport member 420.

In addition, in the present exemplary embodiment, a third movement restriction portion 453 disposed between the facing member 430 and the opposite-direction transport member 420 is provided. The third movement restriction portion 453 restricts movement of a developer moving toward the facing member 430 from the opposite-direction transport member 420.

Furthermore, in the present exemplary embodiment, a fourth movement restriction portion 454 is provided between the one-direction transport member 410 and the opposite-direction transport member 420.

The fourth movement restriction portion 454 restricts movement of a developer moving from the one-direction transport member 410 to the opposite-direction transport member 420. In addition, the fourth movement restriction portion 454 restricts movement of a developer moving from the opposite-direction transport member 420 to the one-direction transport member 410.

In the present exemplary embodiment, the second to fourth movement restriction portions 452 to 454 are integrated with each other. The second to fourth movement restriction portions 452 to 454 are configured by means of one common component.

Furthermore, in the present exemplary embodiment, a fifth movement restriction portion 455 that is disposed between the facing member 430 and the lower-side transport member 440 and that restricts movement of a developer moving toward the facing member 430 from the lower-side transport member 440 is provided.

Furthermore, in the present exemplary embodiment, a magnet roll 145B is provided inside the facing member 430.

The magnet roll 145B is provided with five magnetic poles 121 to 125 arranged in a circumferential direction of the magnet roll 145B.

The magnetic pole 121 is a pickup pole and attracts a developer supplied from the one-direction movement path 191. Accordingly, the developer adheres to a surface of the facing member 430.

The magnetic poles 122 to 124 have a role as transport poles and move the developer on the surface of the facing member 430 to a downstream side in a rotation direction of the facing member 430.

In the rotation direction of the facing member 430, a facing restriction portion 127 is provided downstream of the magnetic pole 122 and upstream of the magnetic pole 123. In addition, the facing restriction portion 127 is disposed at a position facing the outer peripheral surface of the facing member 430.

The facing restriction portion 127 is disposed with a gap provided between the facing restriction portion 127 and the facing member 430.

The facing restriction portion 127 restricts movement of a portion of a developer adhering to the surface of the facing member 430, so that the thickness of the developer adhering to the surface of the facing member 430 becomes a predetermined thickness.

In other words, the facing restriction portion 127 restricts movement of a portion of a developer that adheres to the outer peripheral surface of the facing member 430 and that moves toward the photoreceptor drum 11 as the facing member 430 rotates.

In a case where the developer on the surface of the facing member 430 moves to the downstream side in the rotation direction of the facing member 430, the developer moves to the surface of the photoreceptor drum 11. Toner contained in the developer adheres to the photoreceptor drum 11.

Accordingly, development is performed, and an image consisting of the toner is formed on the surface of the photoreceptor drum 11.

The image is temporarily held by the photoreceptor drum 11 and is moved to the primary transfer unit 10 (refer to FIG. 1) with the photoreceptor drum 11 rotating. Then, the image is transferred to the intermediate transfer belt 15.

A magnetic pole 125 has a role as a pick-off pole. That is, the magnetic pole 125 forms a repulsive magnetic field and causes the developer adhering to the surface of the facing member 430 to be separated from the facing member 430. The magnetic pole 125 causes the developer that remains on the surface of the facing member 430 without being transferred to the photoreceptor drum 11 to be separated from the facing member 430.

In the present exemplary embodiment, separation of the developer occurs at a separation position 296.

In the present exemplary embodiment, the separation position 296 is positioned ahead of the magnetic pole 121 having a role as a pickup pole. In the present exemplary embodiment, the developer is separated ahead of the magnetic pole 121.

The developer separated from the facing member 430 moves downward and reaches the lower-side movement path 193.

The developer that has reached the lower-side movement path 193 is moved toward the one end portion 141 (refer to FIG. 2) side of the developing device 14 by the lower-side transport member 440. Then, the developer is moved to the opposite-direction movement path 192 (refer to FIG. 3).

The one-direction transport member 410 (refer to FIG. 3), the opposite-direction transport member 420, the facing member 430, the magnet roll 145B, and the lower-side transport member 440 are disposed to extend in the direction perpendicular to the paper surface of FIG. 3 and to be parallel to each other.

The one-direction transport member 410 includes the rotary shaft 411 that extends along the longitudinal direction of the developing device 14 and a protruding portion 412 that protrudes from an outer peripheral surface of the rotary shaft 411.

The protruding portion 412 is provided over an area extending from one end portion to the other end portion of the rotary shaft 411 in an axial direction and is provided in a spiral shape. In other words, the protruding portion 412 is provided in a screw-like shape.

In the present exemplary embodiment, in a case where the rotary shaft 411 provided at the one-direction transport member 410 rotates, the protruding portion 412 presses a developer in the axial direction of the rotary shaft 411 and thus the developer moves in a direction in which the rotary shaft 411 extends.

In addition, the opposite-direction transport member 420 and the lower-side transport member 440 have the same configuration as the one-direction transport member 410. That is, the opposite-direction transport member 420 is provided with the rotary shaft 421 extending along the longitudinal direction of the developing device 14 and a protruding portion having a spiral shape. In addition, the lower-side transport member 440 is provided with a rotary shaft 441 extending along the longitudinal direction of the developing device 14 and a protruding portion 442 having a spiral shape.

The one-direction transport member 410, the opposite-direction transport member 420, the facing member 430, and the lower-side transport member 440 are rotating members that rotate around axes extending along the above-described one direction.

In the present exemplary embodiment, an axis 420A of the opposite-direction transport member 420 is positioned to be farther from the facing member 430 than the axis 410A of the one-direction transport member 410 is in a case where the positions of the axes in the horizontal direction are compared with each other.

In addition, in the present exemplary embodiment, the axis 420A of the opposite-direction transport member 420 is positioned at a position offset from a position directly below the axis 410A of the one-direction transport member 410.

In addition, in the present exemplary embodiment, the axis 440A of the lower-side transport member 440 is positioned at a position offset from a position directly below the axis 431 of the facing member 430.

More specifically, in the present exemplary embodiment, the axis 440A of the lower-side transport member 440 is positioned to be closer to the opposite-direction transport member 420 than the axis 431 of the facing member 430 is in a case where the positions of the axes in the horizontal direction are compared with each other.

Furthermore, in the present exemplary embodiment, the axis 440A of the lower-side transport member 440 is positioned below the axis 420A of the opposite-direction transport member 420 in a case where the positions of the axes in a perpendicular direction are compared with each other.

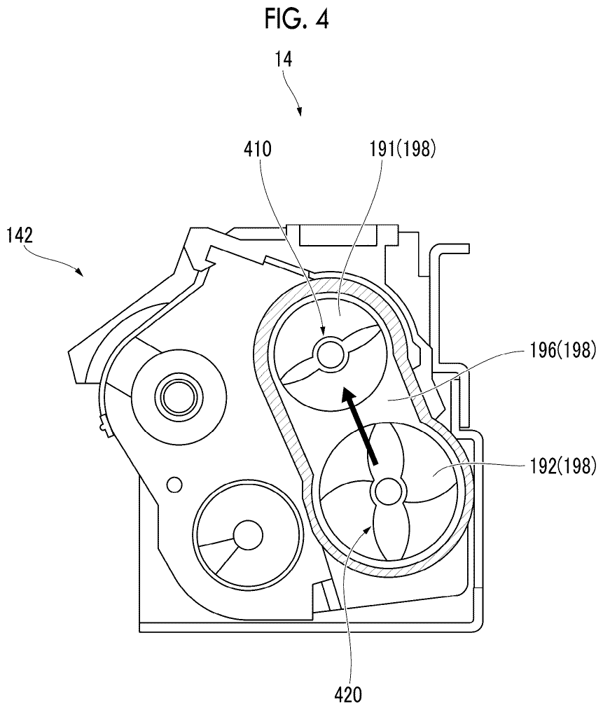

FIG. 4 is a cross-sectional view of the developing device 14 taken along line IV-IV in FIG. 2.

FIG. 4 shows the state of a cross section of the other end portion 142 of the developing device 14.

In the present exemplary embodiment, as shown in FIG. 4, an upward movement path 196 disposed along the vertical direction is provided at the other end portion 142 of the developing device 14.

In the present exemplary embodiment, a developer that has moved through the opposite-direction movement path 192 moves toward the one-direction movement path 191 through the upward movement path 196.

The developing device 14 of the present exemplary embodiment has a configuration in which the upward movement path 196 which is an example of a second movement path, through which a developer moving from the opposite-direction transport member 420 to the one-direction transport member 410 passes, is provided.

Here, the expression “being disposed along the vertical direction” means not only a state where the upward movement path 196 is disposed along the perpendicular direction but also a state where the upward movement path 196 is disposed in a state of being inclined with respect to the perpendicular direction.

In the present exemplary embodiment, in a case where a developer is transported to the other end portion 142 of the developing device 14 by the opposite-direction transport member 420, the developer accumulates at a lower portion of the upward movement path 196. The developer gradually moves upward in the upward movement path 196 after the accumulation.

Accordingly, the developer is supplied to the one-direction transport member 410. The one-direction transport member 410 transports, toward the one end portion 141 (refer to FIG. 2) of the developing device 14 along the one-direction movement path 191, a developer that has moved through the upward movement path 196.

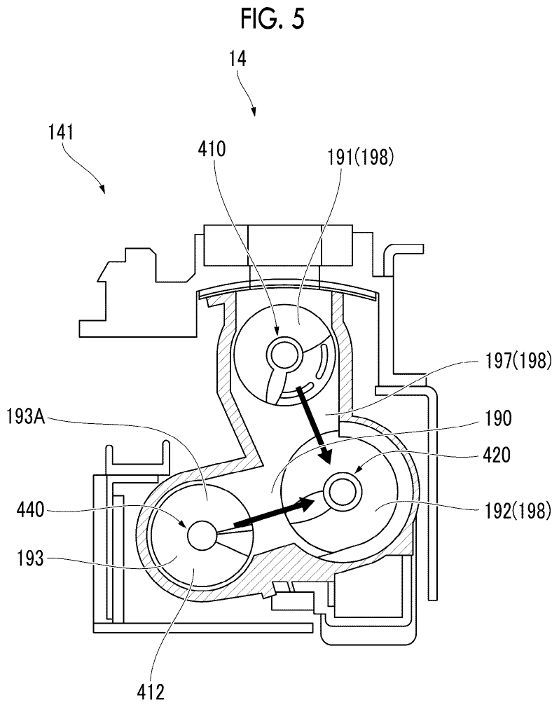

FIG. 5 is a cross-sectional view of the developing device 14 taken along line V-V in FIG. 2.

In the present exemplary embodiment, as shown in FIG. 5, a downward movement path 197 disposed along the vertical direction is provided at the one end portion 141 of the developing device 14.

Here, the expression “being disposed along the vertical direction” means not only a state where the downward movement path 197 is disposed along the perpendicular direction but also a state where the downward movement path 197 is disposed in a state of being inclined with respect to the perpendicular direction.

In the present exemplary embodiment, a developer that has moved through the one-direction movement path 191 moves toward the opposite-direction movement path 192 through the downward movement path 197.

In the present exemplary embodiment, the downward movement path 197 which is an example of a first movement path, through which a developer moving from the one-direction transport member 410 to the opposite-direction transport member 420 passes, is provided.

In the present exemplary embodiment, a developer that has moved through the one-direction movement path 191 moves toward the opposite-direction movement path 192 through the downward movement path 197. Next, the developer moves toward the other end portion 142 (refer to FIG. 2) of the developing device 14 through the opposite-direction movement path 192.

In the developing device 14 of the present exemplary embodiment, a developer movement path 198 that is formed in an annular shape by four paths, which are the one-direction movement path 191, the downward movement path 197, the opposite-direction movement path 192, and the upward movement path 196 (refer to FIG. 4), is provided.

In the present exemplary embodiment, a developer circulates and moves along the annular developer movement path 198.

Furthermore, in the present exemplary embodiment, as shown in FIG. 5, a connection path 190 that extends in a lateral direction and that connects the lower-side movement path 193 and the opposite-direction movement path 192 to each other is provided.

In the present exemplary embodiment, the connection path 190 which is an example of a movement path for a developer moving from the lower-side transport member 440 to the opposite-direction transport member 420 is provided.

The connection path 190 is disposed in a state of being inclined to extend obliquely upward. In other words, the connection path 190 is disposed in a state of being inclined with respect to both the horizontal direction and the perpendicular direction.

In the present exemplary embodiment, a developer that has been moved along the lower-side movement path 193 by the lower-side transport member 440 moves to the opposite-direction movement path 192 through the connection path 190.

In the present exemplary embodiment, a developer accumulating at an end portion of the lower-side movement path 193 that is positioned on a downstream side in a developer movement direction is pressed by a developer sequentially transported from an upstream side. The pressed developer moves to the opposite-direction movement path 192 through the connection path 190.

In the developing device 14 of the present exemplary embodiment, as described above, the annular developer movement path 198 is provided. A developer is agitated as the developer moves through the annular developer movement path 198.

Furthermore, in the present exemplary embodiment, while a developer to be agitated is passing through the one-direction movement path 191 (refer to FIG. 3), the developer is partially supplied to the facing member 430 over the first movement restriction portion 450 and the developer adheres to the surface of the facing member 430.

As the facing member 430 rotates, the developer adhering to the surface of the facing member 430 is moved to a position facing the photoreceptor drum 11 and thus the developer is supplied to the photoreceptor drum 11.

A portion of the developer that adheres to the surface of the facing member 430 and that is not supplied to the photoreceptor drum 11 passes through a position facing the magnetic pole 125 (refer to FIG. 3) having a role as a pick-off pole. In a case where the developer reaches the separation position 296, the developer is separated from the facing member 430 and moves downward.

The developer moving downward reaches the lower-side movement path 193 provided with the lower-side transport member 440.

The developer that has reached the lower-side movement path 193 moves through the lower-side movement path 193 to reach an end portion 193A of the lower-side movement path 193 that is positioned on the downstream side in the developer movement direction.

Thereafter, the developer moves to the opposite-direction movement path 192 through the connection path 190 by being pressed by a developer sequentially transported from the upstream side.

In a case where the developer moves to the opposite-direction movement path 192, the developer moves along the annular developer movement path 198 again.

### First Exemplary Embodiment

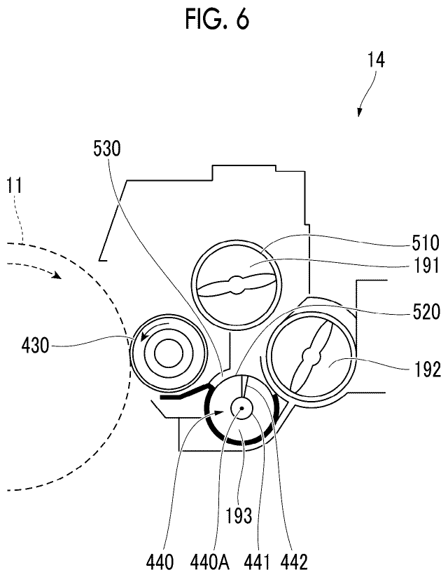

FIG. 6 is a view for description of the developing device 14 according to a first exemplary embodiment. FIG. 6 is a schematic view showing the developing device 14 that is seen in a direction along the rotary shaft 441 of the lower-side transport member 440 such that the photoreceptor drum 11 is positioned to the left of the facing member 430 as in the cases of FIGS. 3 to 5 described above.

The configuration of the developing device 14 according to the first exemplary embodiment shown in FIG. 6 will be described including the above-described contents.

The developing device 14 is a device that causes a developer to adhere to the photoreceptor drum 11 and has a configuration as follows. The developing device 14 includes the facing member 430 that is rotatably disposed at a position facing the photoreceptor drum 11.

In addition, the developing device 14 includes a first accommodation portion 510 that accommodates a developer to be supplied to the facing member 430 and a second accommodation portion 520 that receives and accommodates a developer separated from the facing member 430. The second accommodation portion 520 is provided separately from the first accommodation portion 510.

That is, in the developing device 14, a developer is supplied to the facing member 430 from the first accommodation portion 510 and a developer separated from the facing member 430 is received by the second accommodation portion 520. As described above, the functions of the developing device 14 are made separate from each other since the first accommodation portion 510 has a function of supplying a developer and the second accommodation portion 520 has a function of receiving a developer.

The first accommodation portion 510 forms the one-direction movement path 191 described above. That is, the first accommodation portion is formed by, for example, constituent members including the first movement restriction portion 450 (refer to FIG. 3) and the fourth movement restriction portion 454 (refer to FIG. 3).

The second accommodation portion 520 forms the lower-side movement path 193 described above. That is, the second accommodation portion 520 is formed by, for example, constituent members including the second movement restriction portion 452 (refer to FIG. 3).

In addition, the second accommodation portion 520 includes the above-described lower-side transport member 440 provided therein. In the second accommodation portion 520, a developer accommodated in the second accommodation portion 520 is transported as the lower-side transport member 440 rotates.

In the developing device 14, a developer separated from the facing member 430 is received by the second accommodation portion 520 via a region 530. That is, the developing device 14 includes the region 530 provided between the facing member 430 and the second accommodation portion 520. The region 530 is a region in which the second accommodation portion 520 receives a developer separated from the facing member 430.

Here, in the case of the developing device 14 including the first accommodation portion 510 and the second accommodation portion 520 separately as described above, it is necessary to prevent a developer separated from the facing member 430 from adhering to the facing member 430 again. Since the above-described region 530 is a region connecting the facing member 430 and the second accommodation portion 520 to each other, a developer accommodated in the second accommodation portion 520 may adhere to the facing member 430 again.

In addition, such re-adhesion is likely to occur although depending on a positional relationship between the lower-side transport member 440 and the facing member 430 partly because the facing member 430 rotates counterclockwise. Furthermore, in a case where an interval between the first accommodation portion 510 and the second accommodation portion 520 is narrowed or the photoreceptor drum 11 is caused to rotate at a high speed, the re-adhesion is more likely to occur.

Therefore, the developing device 14 according to the first exemplary embodiment has a configuration for prevention of re-adhesion. Description thereof will be made below.

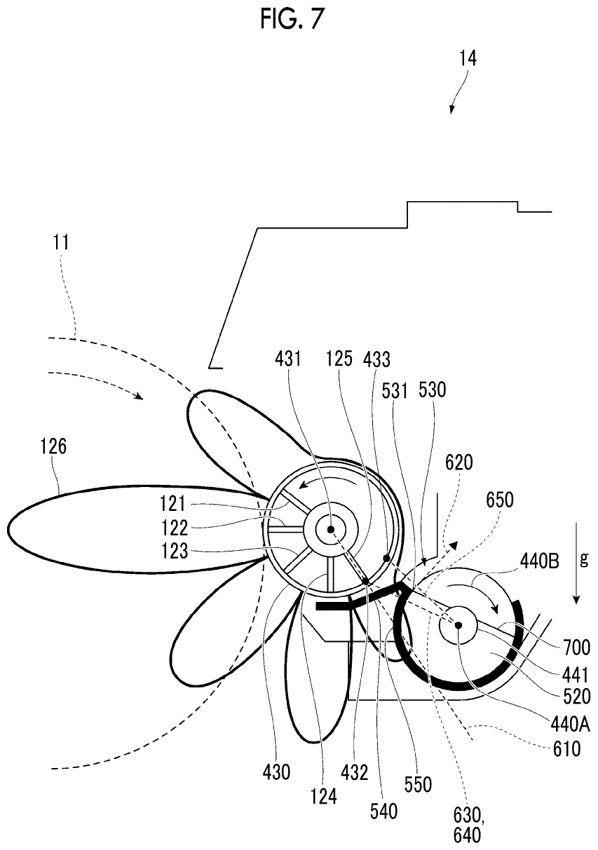

FIG. 7 is a view for description of a major part of the developing device 14. FIG. 7 is a schematic view showing the developing device 14 that is seen in the direction along the rotary shaft 441 of the lower-side transport member 440 such that the photoreceptor drum 11 is positioned to the left of the facing member 430 as in the case of FIG. 6 described above.

Note that in FIG. 7, the first accommodation portion 510 and the one-direction movement path 191 are not shown and the opposite-direction movement path 192 is not shown.

As shown in FIG. 7, the developing device 14 includes a partition wall 540 positioned between the facing member 430 and the second accommodation portion 520. The partition wall 540 is a member that partitions a space between the facing member 430 and the second accommodation portion 520 except the above-described region 530. That is, the partition wall 540 does not partition the entire space between the facing member 430 and the second accommodation portion 520 and the partition wall 540 partitions the space such that the second accommodation portion 520 can receive a developer separated from the facing member.

As described above, the facing member 430 includes the five magnetic poles 121 to 125 arranged in the circumferential direction. More specifically, the facing member 430 includes the magnetic pole 125 serving as a pick-off pole.

A magnetic pole attraction force distribution 126 in normal directions, which is represented by a bold line, is set with the magnetic poles 121 to 125 disposed in this manner. The magnetic pole attraction force distribution 126 indicates that the thickness of a developer layer, that is, the height of the layer from the surface of the facing member 430 changes depending on a position in a circumferential direction of the facing member 430.

In the developing device 14, the lower-side transport member 440 is disposed at a predetermined position with respect to the facing member 430. That is, in a case where a virtual line passing through the axis 431 and the magnetic pole 125 in the facing member 430 is referred to as a virtual line 610 of the facing member 430, the axis 440A of the lower-side transport member 440 is positioned above the virtual line 610 of the facing member 430. In addition, the axis 440A of the lower-side transport member 440 is positioned to the right of the virtual line 610 of the facing member 430. Regarding the positional relationship between the axis 440A and the virtual line 610, the axis 440A may be positioned above or to the right of the virtual line 610.

Note that the lower-side transport member 440 is an example of a transport member, and the rotary shaft 441 is an example of a rotary shaft of the transport member. The axis 431 of the facing member 430 is an example of a rotation center of the facing member. The virtual line 610 is an example of a first virtual line.

More specifically, in a case as shown in FIG. 7, the lower-side transport member 440 of the lower-side movement path 193 rotates in a clockwise direction 440B. That is, the lower-side transport member 440 rotates in a direction away from the facing member 430 in the region 530.

In addition, as shown in FIG. 7, a virtual line 620 extending in a tangential direction at the position of a left end 531 of the region 530 does not extend in a direction toward the facing member 430 and does not intersect the facing member 430. The position of the left end 531 in FIG. 7 mentioned herein is the position of an upstream end of the region 530 in a direction of rotation of the lower-side transport member 440. In addition, the position of the left end 531 in FIG. 7 is the position of a downstream end of the partition wall 540 in the direction of rotation of the lower-side transport member 440. Note that the position of the left end 531 in FIG. 7 can be referred to as the position of a top of the partition wall 540 or the position of a right end of the partition wall 540.

In the first exemplary embodiment, since the above-described configuration is adopted, occurrence of a situation in which a developer in the second accommodation portion 520 is scattered onto the surface of the facing member 430 due to rotation of the lower-side transport member 440 is suppressed and re-adhesion to the facing member 430 is prevented.

Note that the region 530 is an example of a region for reception of a developer separated from the facing member and is an example of a region for reception. The virtual line 620 is an example of a second virtual line.

Here, as shown in FIG. 7, the position of the left end 531 of the region 530 is higher than the position of the rotary shaft 441 of the lower-side transport member 440 (refer to FIG. 3) in a gravity direction g. That is, in a case where the left end 531 of the region 530 and the rotary shaft 441 of the lower-side transport member 440 (refer to FIG. 3) are compared with each other in the gravity direction g, the left end 531 is higher than the rotary shaft 441.

In addition, as shown in FIG. 7, the lower-side transport member 440 is covered by a cover member 550 at a position to the left of the left end 531 of the region 530.

As described above, in the first exemplary embodiment, in a case where the second accommodation portion 520 shown in FIG. 7 is likened to a clock face, the cover member 550 covers the lower-side transport member 440 up to a position above a position corresponding to 9:00.

Accordingly, a developer separated from the facing member 430 and accommodated in the second accommodation portion 520 is restrained from sticking onto the facing member 430.

More specifically, since the lower-side transport member 440 of the second accommodation portion 520 rotates in the clockwise direction in a case shown in FIG. 7, the developer accommodated in the second accommodation portion 520 is one-sided in the clockwise direction 440B. That is, an upper surface 700 of the developer is inclined to connect a position below a position corresponding to 3:00 and a position above the position corresponding to 9:00. Therefore, since a configuration in which the cover member 550 covers the lower-side transport member 440 up to the position above the position corresponding to 9:00 is adopted, the developer can be prevented from spilling over the second accommodation portion 520.

Note that as shown in FIG. 7, the virtual line 610 extends to intersect the cover member 550.

Here, as shown in FIG. 7, the cover member 550 overlaps with a virtual line 630 passing through a first surface position 432 of the magnetic pole 125 at the facing member 430 and the axis 440A of the lower-side transport member 440.

Accordingly, occurrence of a situation in which a developer separated from the facing member 430 and accommodated in the second accommodation portion adheres to the facing member 430 again is further prevented.

Note that the first surface position 432 of the magnetic pole 125 is an example of the position of a magnetic pole disposed at a downstream end in a developer transportation direction in the facing member. The axis 440A of the lower-side transport member 440 is an example of a rotation axis of the transport member. The virtual line 630 with respect to the cover member 550 is an example of a third virtual line.

Here, in an example shown in FIG. 7, the cover member 550 is configured to be integrated with the partition wall 540. Accordingly, a developer separated from the facing member 430 may be more reliably accommodated.

Meanwhile, it is also conceivable to configure the cover member 550 by using a member different from the partition wall 540.

Here, in the example shown in FIG. 7, the cover member 550 is configured to be integrated with members constituting the second accommodation portion 520. More specifically, the cover member 550 is configured to be integrated with the second movement restriction portion 452 (refer to FIG. 3) and the like constituting a portion of the second accommodation portion 520. Accordingly, the number of components of the developing device 14 may be reduced.

Meanwhile, it is also conceivable to configure the cover member 550 by using a member different from the second accommodation portion 520.

Here, as shown in FIG. 7, the partition wall 540 overlaps with a virtual line 640 passing through the first surface position 432, which is the position of a surface of the magnetic pole 125 at the facing member 430, and the axis 440A of the lower-side transport member 440.

Accordingly, occurrence of a situation in which a developer separated from the facing member 430 and accommodated in the second accommodation portion adheres to the facing member 430 again is further prevented. In the first exemplary embodiment, as shown in FIG. 7, the virtual line 640 is at the same position as the virtual line 630 described above.

Note that the first surface position 432 of the magnetic pole 125 is an example of the position of a magnetic pole disposed at a downstream end in a developer transportation direction in the facing member. The axis 440A of the lower-side transport member 440 is an example of a rotation axis of the transport member. The virtual line 640 with respect to the partition wall 540 is an example of a fourth virtual line.

In addition, as shown in FIG. 7, the virtual line 640 intersects the virtual line 610 and the first surface position 432 of the facing member 430. Accordingly, occurrence of re-adhesion is further prevented.

More specifically, a second surface position 433 shown in FIG. 7 is a position on the surface of the facing member 430. In addition, the second surface position 433 is a position where a magnetic force of the magnetic pole 125 is lost, as is apparent from the magnetic pole attraction force distribution 126. The second surface position 433 is downstream of the first surface position 432 in the rotation direction of the facing member 430.

In addition, the partition wall 540 does not intersect a virtual line 650 passing through the second surface position 433 of the facing member 430 and the axis 440A of the lower-side transport member 440. That is, as shown in FIG. 7, the position of the top of the partition wall 540 (the position of the left end 531) is lower than the virtual line 650.

Separation failure of a developer from the facing member 430, which is caused in a case where the partition wall 540 extends to be long in a direction toward a downstream side of the facing member 430, may be prevented.

Note that the axis 440A of the lower-side transport member 440 is an example of a rotation axis of the transport member. The virtual line 650 is an example of a fifth virtual line.

Second Exemplary Embodiment

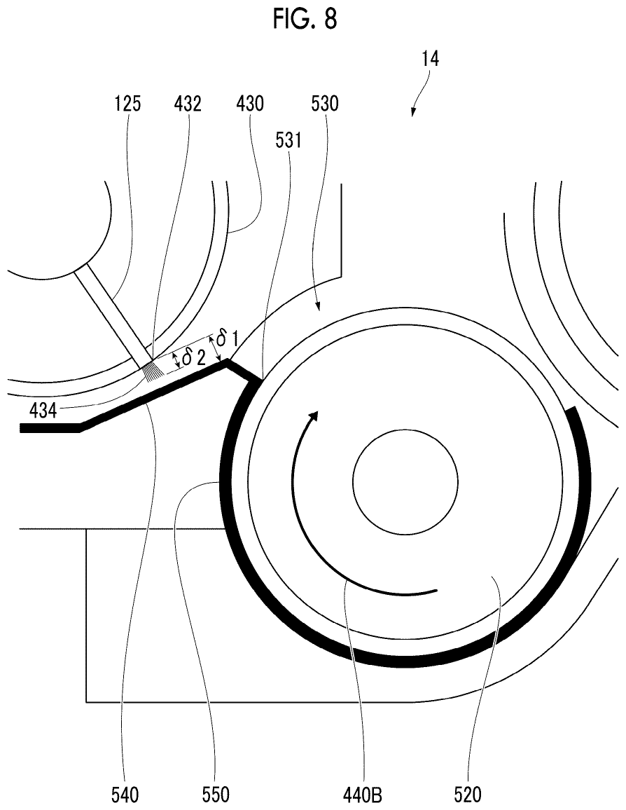

FIG. 8 is a view for description of the developing device 14 according to a second exemplary embodiment, and is an enlarged view of the vicinity of the partition wall 540 shown in FIG. 7. Since the second exemplary embodiment has components common to the first exemplary embodiment described above, the same reference numerals are used for the common components and description about the common components may be omitted.

As shown in FIG. 8, in the case of the second exemplary embodiment, the size of a gap between the partition wall 540 and the surface of the facing member 430 is a distance δ1. In addition, the height of a magnetic brush 434 of the magnetic pole 125 of the facing member 430 is a distance δ2 from the surface of the facing member 430. In addition, in a case where the distance δ1 corresponding to the gap is compared with the distance δ2 corresponding to the height of the magnetic brush 434, the distance δ1 is larger than the distance δ2 (δ1>δ2). That is, the magnetic brush is set in a state of not coming into contact with the partition wall 540.

Although the exemplary embodiments of the present invention have been described above, the technical scope of the exemplary embodiments of the present invention is not limited to the above exemplary embodiments. In addition, various modifications and alternative configurations are involved in the present invention without departing from the technical scope of the present invention.

### Supplementary Note

(((1)))

A developing device that is composed of a plurality of constituent members and that causes a developer to adhere to an image holding body holding an image, the developing device comprising:

a facing member that is disposed as a constituent member to be rotatable at a position facing the image holding body and that includes a magnetic pole acting such that the developer is separated;

a second accommodation portion that is provided separately from a first accommodation portion accommodating the developer to be supplied to the facing member, that receives and accommodates the developer separated from the facing member, and in which the accommodated developer is transported as a transport member rotates; and

a partition wall that partitions a space between the facing member and the second accommodation portion except a region for reception of the developer separated from the facing member,

wherein, in a case of being seen in a direction along a rotation axis of the transport member such that the image holding body is positioned to left of the facing member, the rotation axis of the transport member is positioned above or to right of a first virtual line passing through a rotation center of the facing member and the magnetic pole, the transport member rotates in a direction away from the facing member in the region for the reception, and a second virtual line extending in a tangential direction at a position of a left end of the region for the reception does not intersect the facing member.

(((2)))

The developing device according to (((1))),

wherein, in a case of being seen in the direction along the rotation axis of the transport member such that the image holding body is positioned to the left of the facing member, the position of the left end is higher than a position of the rotation axis in a gravity direction and the transport member is covered by a cover member at a position to left of the position of the left end.

((((3))))

The developing device according to (((2))),

wherein the cover member overlaps with a third virtual line that passes through a position of the magnetic pole disposed at a downstream end in a developer transportation direction in the facing member and the rotation axis of the transport member.

((((4))))

The developing device according to (((2))) or (((3))),

wherein the cover member is configured to be integrated with the partition wall.

((((5))))

The developing device according to any one of (((2))) to (((4))),

wherein the cover member is configured to be integrated with the second accommodation portion.

((((6))))

The developing device according to (((1))),

wherein the partition wall overlaps with a fourth virtual line that passes through a position of the magnetic pole disposed at a downstream end in a developer transportation direction in the facing member and the rotation axis of the transport member.

(((7)))

The developing device according to (((6))),

wherein the fourth virtual line intersects the first virtual line at a surface position of the facing member.

(((8)))

The developing device according to (((7))),

wherein the partition wall does not intersect a fifth virtual line that passes through a position where a magnetic force at the surface position generated by the magnetic pole disposed at the downstream end is lost and the rotation axis of the transport member.

(((9)))

The developing device according to any one of (((6))) to (((8))),

wherein the partition wall is disposed such that a brush height of the magnetic pole is smaller than a size of a gap between the partition wall and the facing member.

(((10)))

An image forming apparatus comprising:

the developing device according to any one of (((1))) to (((9))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device that is composed of a plurality of constituent members and that causes a developer to adhere to an image holding body holding an image, the developing device comprising:
a facing member that is disposed as a constituent member to be rotatable at a position facing the image holding body and that includes a magnetic pole acting such that the developer is separated;
a second accommodation portion that is provided separately from a first accommodation portion accommodating the developer to be supplied to the facing member, that receives and accommodates the developer separated from the facing member, and in which the accommodated developer is transported as a transport member rotates; and
a partition wall that partitions a space between the facing member and the second accommodation portion except a region for reception of the developer separated from the facing member,
wherein, in a case of being seen in a direction along a rotation axis of the transport member such that the image holding body is positioned to left of the facing member, the rotation axis of the transport member is positioned above or to right of a first virtual line passing through a rotation center of the facing member and the magnetic pole, the transport member rotates in a direction away from the facing member in the region for the reception, and a second virtual line extending in a tangential direction at a position of a left end of the region for the reception does not intersect the facing member.

2. The developing device according to claim 1,
wherein, in a case of being seen in the direction along the rotation axis of the transport member such that the image holding body is positioned to the left of the facing member, the position of the left end is higher than a position of the rotation axis in a gravity direction and the transport member is covered by a cover member at a position to left of the position of the left end.

3. The developing device according to claim 2,
wherein the cover member overlaps with a third virtual line that passes through a position of the magnetic pole disposed at a downstream end in a developer transportation direction in the facing member and the rotation axis of the transport member.

4. The developing device according to claim 2,
wherein the cover member is configured to be integrated with the partition wall.

5. The developing device according to claim 2,
wherein the cover member is configured to be integrated with the second accommodation portion.

6. The developing device according to claim 1,
wherein the partition wall overlaps with a fourth virtual line that passes through a position of the magnetic pole disposed at a downstream end in a developer transportation direction in the facing member and the rotation axis of the transport member.

7. The developing device according to claim 6,
wherein the fourth virtual line intersects the first virtual line at a surface position of the facing member.

8. The developing device according to claim 7,
wherein the partition wall does not intersect a fifth virtual line that passes through a position where a magnetic force at the surface position generated by the magnetic pole disposed at the downstream end is lost and the rotation axis of the transport member.

9. The developing device according to claim 6,
wherein the partition wall is disposed such that a brush height of the magnetic pole is smaller than a size of a gap between the partition wall and the facing member.

10. An image forming apparatus comprising:
the developing device according to claim 1.

11. An image forming apparatus comprising:
the developing device according to claim 2.

12. An image forming apparatus comprising:
the developing device according to claim 3.

13. An image forming apparatus comprising:
the developing device according to claim 4.

14. An image forming apparatus comprising:
the developing device according to claim 5.

15. An image forming apparatus comprising:
the developing device according to claim 6.

16. An image forming apparatus comprising:
the developing device according to claim 7.

17. An image forming apparatus comprising:
the developing device according to claim 8.

18. An image forming apparatus comprising:
the developing device according to claim 9.
